(19) United States
(12) Patent Application Publication
(10) Pub. No.: US 2011/0113429 A1
(43) Pub. Date: May 12, 2011

(54) INCIDENT MANAGEMENT METHOD AND OPERATION MANAGEMENT SERVER

(76) Inventor: Takuya ODA, Yokohama (JP)

(21) Appl. No.: 12/703,013

(22) Filed: Feb. 9, 2010

(30) Foreign Application Priority Data
Nov. 10, 2009 (JP) 2009-257131

(51) Int. Cl. G06F 9/46

(52) U.S. Cl. 718/102

(57) ABSTRACT

An operation management server, including an incident-job relation specifying unit, is responsive to the occurrence of an incident generated in an business system to refer to the incident table for relating the incident to hosts and the job group definition table from a job management server in order to specify the job and job group to be executed by the host on which the incident is generated, a job execution estimation unit for specifying the job to be reexecuted due to the occurrence of the incident and the unexecuted job in the job group, and an impact on job execution calculation unit for determining the impact on job execution which is the influence by the incident on the business system by relating the incident to the specified job.

### INCORPORATION BY REFERENCE

This application claims priority based on Japanese patent application, No. 2009-257131 filed on Nov. 10, 2009, the entire contents of which are incorporated herein by reference.

### FIELD OF THE INVENTION

The present invention is directed to an incident management method and to an operation management server which manages incidents.

### BACKGROUND OF THE INVENTION

In general, when the business system of a large firm using IT goes down for an hour due to a system failure or for maintenance, the firm is said to lose approximately few millions to tens of million yen. In order to minimize the amount of loss due to the down of the business system, it is required to deal with the incidents of the business system fast and efficiently. In recent years, the introduction of the server virtualization technology has made it possible to deal with one incident efficiently and fast. On the other hand, since the number of incidents is not decreased, a method is required for efficiently dealing with all the incidents such as by assigning the degree of high priority or by allocating evenly a person in charge.

There are technologies as disclosed, for example, in Japanese published unexamined application 2008-217285 and Japanese patent No. 3276834 which efficiently deal with the incidents. In Japanese published unexamined application 2008-217285, there is disclosed a method for computing the degree of influence that the emerged incident impacts a service in an information processing system which provides many services, and for presenting to the user thus calculated degree of influence. In Japanese patent No. 3276834, the degree of high priority is determined when dealing with an incident by calculating the probability of completion of the dealing work by the dealing deadline of the incident and by using thus calculated probability of the completion of the work.

In accordance with the technology described in Japanese published unexamined application 2008-217285, the calculation of the influence requires the identification of the resource identical to the resource (of hardware as well as software) which is the source origin of the incident; the influence by the incident with respect on the service is calculated based on the business status and the number of the identical resource.

In accordance with the technology described in Japanese patent No. 3276834, in a case in which the probability of completing the dealing work by the predetermined dealing completion deadline of the incident is calculated and if there are plural dealing work processes to be undertaken prior to the completing deadline, a dealing work process to be done having lesser probability of completion is assigned a priori to the worker. The probability of completion is calculated by identifying many similar incidents having onset previously, and by comparing the time having required for the deal with the identified incident with the dealing deadline of completion of the incident having onset.

### SUMMARY OF THE INVENTION

In accordance with the method described in Japanese published unexamined application 2008-217285 above, the business status and the number of the resource identical to the resource of the source origin of the incident, in other words, the current status determines the influence on the services. This means that the influence of the incident cannot be determined with respect on the job not to be running in the present time but to be done in the future or to the job to be done again. The influence of the incident on the job execution is to be calculated based on the calculation of prediction by estimating not only the current status but also the future status. For example, in a case in which there is a job group which binds up plural jobs for executing a process, if the job execution is halted by an incident which onsets in the middle of the execution of the job group, the number of jobs to be done will be different. Even though the same job group is qualified, there may be a case in which the suspended job can be reexecuted without problems (the job which does not affect to the following jobs such as the job after the data is once stored in the database), and there may also be a case in which all jobs are to be done again entirely (for example the job which affects to the following jobs, such as the job for storing in the database the data for use in the following jobs), depending on where incidents occur. In accordance with the method described in Japanese published unexamined application 2008-217285, as both cases are incidents with respect to the identical job group, the identical influence will be calculated with respect to the execution of the job group because the business status and the number of resources are the same. However, in reality, the amount of jobs to be reexecuted in the future may be different, so that the influence by the incidents with respect to the execution of the job group may be different.

In accordance with the method described in Japanese patent No. 3276834, the probability of completion of the incident is first calculated based on the dealing deadline of the completion of the incident and based on the temporal history of the dealing work having done previously. Then the importance of the incident, in other words the priority is multiplied thereto to determine the estimated value of the dealing completion of the incident, and the incident having higher estimation value is allocated on a priority basis. Japanese patent No. 3276834 assumes that the priority is registered in correspondence to the incident in advance. This means an attempt to minimize the influence by the incident by dealing with the incident having a higher priority, but the degree and range of influence are not considered.

In the present description the influence by the incident with respect to the business system is referred to as the impact on job execution, in association with the jobs or job groups to be executed or reexecuted by the business execution servers which includes the business system as well as the jobs or job groups having their execution already scheduled.

An aspect of the present invention provides an operation management server for managing incidents, connected to an business system including business execution servers referred to as hosts to a job management server for managing the execution of jobs by the business execution servers, including:

an incident-job relation specifying unit, which specifies jobs and job groups executed by the hosts on which the incidents are generated, by referring to an incident table in response to the generation of the incident generated on the business system, the incident table associating each of the incidents with one of the hosts on which the incidents are generated, as well as by referring to a job group definition table from the job management server, the table associates the job group including the jobs and the jobs executed by the hosts with the hosts;

a job execution estimation unit, which specifies jobs which are to be reexecuted due to the generated incident or which are unexecuted, by referring to the execution status of the jobs presented in a job execution schedule table from the job management server; and

an impact on job execution calculation unit, which determines the impact on job execution affected by the incident to the business system by associating the incident with the job specified.

In another preferable aspect of the present invention, the impact on job execution calculation unit determines the impact on job execution as for at least one of:

(1) the number of the specified jobs presented in the job execution schedule table;

(2) the execution time of the specified job presented in the job execution schedule table;

(3) the number of the hosts to execute the specified jobs presented in the job group definition table;

(4) the redundancy of the hosts to execute the specified jobs presented in the job group definition table; and

(5) the times of scheduled execution of the job group presented in the job execution schedule table by the dealing completion schedule time and date of the incident by referring to the dealing time history table associating the incident with the dealing time.

The problems and the means for solving the problems disclosed in the present application will be clearly described in the following section of the best mode for carrying out the invention and the accompanying drawings.

According to the present invention, the influence by the incident on the business system is output as the quantitative impact on job execution which is associated with the job or job group to be executed or reexecuted by the business execution server constituting an business system or with the job or job group having the execution already scheduled, and the dealing with the incident by the system administrator may be assisted.

### BRIEF DESCRIPTION OF THE DRAWINGS

FIG. 1 is a schematic block diagram indicating an example system configuration of an information processing system;

FIG. 2 is an example of incident table;

FIG. 3 is an example of incident-job relation table;

FIG. 4 is an example of reexecution start job table;

FIG. 5 is an example of impact on job example table;

FIG. 6 is an example of dealing time history table;

FIG. 7 is an example of estimated dealing time table;

FIG. 8 is an example of job group definition table;

FIG. 9 is an example of job execution schedule table;

FIG. 10 is an example of job reexecution definition table;

FIG. 11 is an exemplary hardware configuration of the computer used for such as the operation management server;

FIG. 12 is an exemplary flow diagram of the calculation process of the impact on job execution; and

FIG. 13 is an exemplary flow diagram of the addition process of the impact on job execution.

### DESCRIPTION OF THE PREFERRED EMBODIMENTS

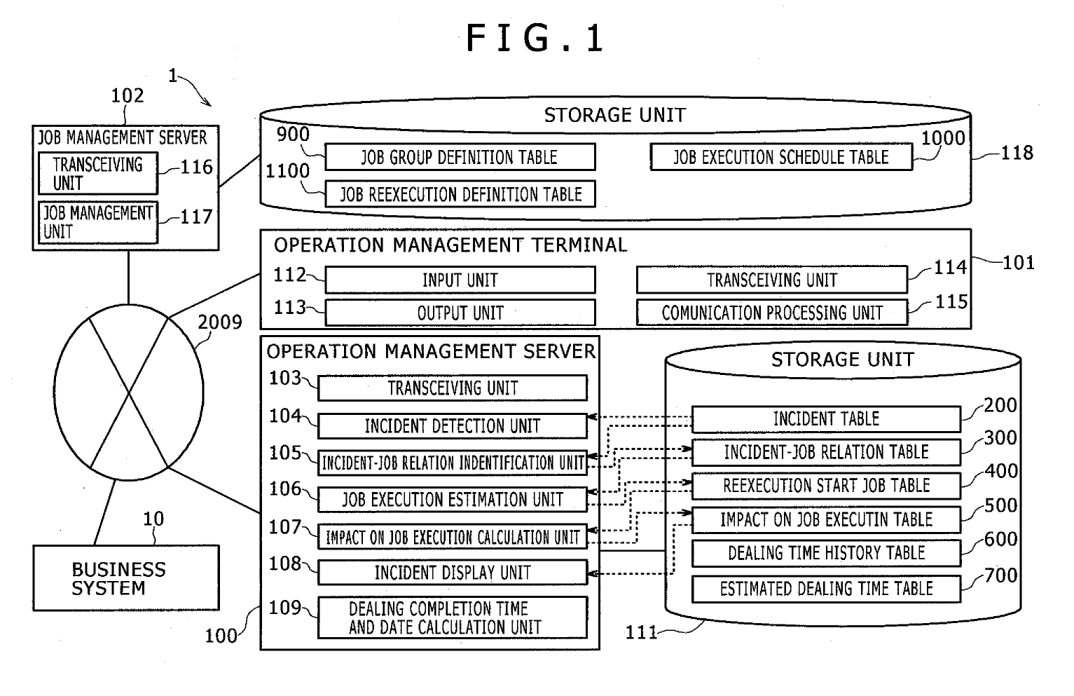

Now referring to FIG. 1 there is shown a schematic block diagram indicating an exemplary configuration of an information processing system 1. The information processing system 1 in the present embodiment includes an operation management server 100, an operation management terminal 101, a job management server 102, and an business system 10 which includes business execution servers. These units are interconnected through the network 2009 so as to be communicable each other. the operation management server 100, the operation management terminal 101, the job management server 102, and the business execution servers are built as computers having a standard hardware configuration, including a CPU, a memory (RAM, ROM, etc.), data i/o interface, communication interface (NIC, etc.), an auxiliary storage device for storing software programs (disc device, etc.), input devices such as a keyboard and a mouse, a display device, and an output device such as a printer.

The process done in the processing unit (for example a job execution estimation unit 106) of the operation management server 100, the operation management terminal 101, and the job management server 102 are achieved by reading out a program stored in the auxiliary storage device into the memory and by executing it by the CPU.

The operation management server 100 executes the management with respect to the operation including the load, failure, maintenance and so on of the business system 10, and determines the influence (the impact on job execution) by the incident emerged on the business system 10 in order to help dealing with the emerged incident by the system administrator. The operation management server 100 thus has the functionality as the incident management device. The operation management terminal 101 is a terminal for use as the interface to the system administrator of the information processing system 1 or the business system 10 for the execution of the operation management server 100. The job management server 102 manages the job (program) to be executed by the business execution servers constituting the business system 10.

Now the operation management server 100 will be described in greater details. The operation management server 100 is a server computer, which executes the process for calculating the impact on job execution by the incident to the execution of the job group which relates to the incident emerged in the business system 10 including the business execution servers. The business system 10 is a system for executing the business process required for operating a firm, including wholesale, manufacturing, accounting, logistics, and so on, and typical business system includes a financial management system, a payroll management system, an online shopping system, and a business management system. An incident is failure information or maintenance information which is generated in the business system 10. A job is a program to be executed by the business execution servers in order to achieve the business in the business system 10; a job group is a group including one or more jobs to be executed by the business execution servers for executing a series of business on the business system 10. The impact on job execution is a degree of influence that the incident in the business system 10 has on the execution of job group at the present time or later.

The operation management server 100 has a transceiving unit 103, an incident detection unit 104, an incident-job relation identification unit 105, a job execution estimation unit 106, an impact on job execution calculation unit 107, an incident display unit 108, a dealing completion time and date calculation unit 109, and a storage unit 111.

The transceiving unit 103 performs the communication process of the operation management server 100. The transceiving unit 103 sorts the information received from the operation management terminal 101 or the job management server 102 through the network 2009 to the processing units in the operation management server 100 specified by the received information. The transceiving unit 103 also transmits through the network 2009 the information to be sent from the processing units of the operation management server 100 to the operation management terminal 101 or to the job management server 102.

The incident detection unit 104 reads out an incident table 200 from the storage unit 111, and verifies the incident table 200 if there is a newly added incident therein. A new incident added to the incident table 200 may be registered by an incident detection mechanism including some hardware or software of which the detailed description is omitted, and may be deleted in accordance with the deal with the incident (reexecution of the job).

The incident-job relation identification unit 105 reads out the incident table 200 from the storage unit 111, transmits a message request for requesting a job group definition table 900 to the job management server 102 through the transceiving unit 103, reads the received job group definition table 900, specifies the job and job group which relates to the incident, associates the identification information of the incident with the job identification information and the job group identification information, and stores the information into the incident-job relation table 300 as described later in the storage unit 111.

The job execution estimation unit 106 reads out the incident-job relation table 300 from the storage unit 111, transmits a message request for requesting a job execution schedule table 1000 through the transceiving unit 103 to the job management server 102, then reads out thus received job execution schedule table 1000. Then it refers to the job execution schedule table 1000 to determine whether this job is the starting job in the job group including this job at the time when the job group is reexecuted, based on the execution status of the job that relates to the incident. If the job is the starting job, then the identification information of this job is stored in a reexecution start job table 400.

The job execution estimation unit 106, in a second embodiment as will be described later in this document, reads out the incident table 200 from the storage unit 111, transmits a message request for requesting the job group definition table 900 and a job reexecution definition table 1100 through the transceiving unit 103 to the job management server 102, reads the received job group definition table 900 and the job reexecution definition table 1100, specifies the starting job at the time of reexecution of the job that relates to the incident, then specifies the job in the job group, which is scheduled to execute after the reexecution starting job based on the execution order (tier) in the job group of the reexecution starting job.

The impact on job execution calculation unit 107 performs an aggregation of the number of jobs scheduled to be executed, and stores the number of counted jobs in an impact on job execution table 500 in the storage unit 111 as the impact on job execution of the incident.

The impact on job execution calculation unit 107, in the third preferred embodiment as will be described later in this document, transmits a message request for requesting a job group execution history table 1400 through the transceiving unit 103 to the job management server 102, reads out thus received job group execution history table 1400, calculates the estimation value of the execution time of the job scheduled to be executed, and stores the calculated estimation time as the impact on job execution of the incident into the impact on job execution table 500 in the storage unit 111.

The impact on job execution calculation unit 107, in the fourth preferred embodiment of the present invention as will be described later in this document, specifies the host to execute the job scheduled to be executed, from the received job group definition table 900, performs an aggregation of the number of the executing hosts, and stores the counted number of hosts as the impact on job execution of the incident into the impact on job execution table 500 of the storage unit 111.

The impact on job execution calculation unit 107, in the fifth preferred embodiment of the present invention as will be described later in this document, specifies the executing host of the job scheduled to be executed from within the received job group definition table 900, then aggregates for each job the redundancy of the executing hosts (number of hosts which may perform the job in place of the host specified to execute the job), then stores the smallness of the redundancy as the impact on job execution of the incident into the impact on job execution table 500 in the storage unit 111.

The impact on job execution calculation unit 107, in the sixth preferred embodiment of the present invention as will be described later in this document, reads out the estimated dealing time table 700 to be described later, transmits a message request for requesting a job group execution schedule 1500 through the transceiving unit 103 to the job management server 102, reads out the received job group execution schedule 1500, aggregates the scheduled number of execution of the job group from the present time to the dealing required time for each incident, and stores the scheduled number of execution as the impact on job execution of the incident into the impact on job execution table 500 in the storage unit 111.

The impact on job execution calculation unit 107 determines the degree of impact on the business system 10 in correspondence with the emerged incident, and displays on the output device as the impact on job execution in response to the request from the administrator. The impact on job execution is displayed quantitatively in relation to the job or job group already scheduled to be done. Some examples of the impact on job execution will be described later in the first to sixth preferred embodiments of the present invention. A combination of some described examples of the impact on job execution may be another example of the impact on job execution.

The incident display unit 108 reads out the incident table 200 and the impact on job execution table 500, and displays on an output device 2008 as will be described later the impact on job execution of each incident recorded in the impact on job execution table 500 along with the information of each incident stored in the incident table 200.

The dealing completion time and date calculation unit 109, in the sixth preferred embodiment, reads out the incident table 200 and a dealing time history table 600, compares the incident contents and the host of each incident stored in the incident table 200 with the incident contents and the host of each incident stored in the dealing time history table 600, specifies the incidents similar to each incident stored in the incident table 200 from within the incidents stored in the dealing time history table 600, and calculates the dealing requiring time for each incident to store in the incident dealing completion deadline time and date table 1200.

The storage unit 111 is connected to the operation management server 100 to store the incident table 200, the incident-job relation table 300, and the impact on job execution table 500, the dealing time history table 600, and the estimated dealing time table 700.

The incident table 200 is a spreadsheet style data, for storing information on the incidents not yet dealt among the incidents emerged in the business system 10 subject to be managed by the operation management server 100.

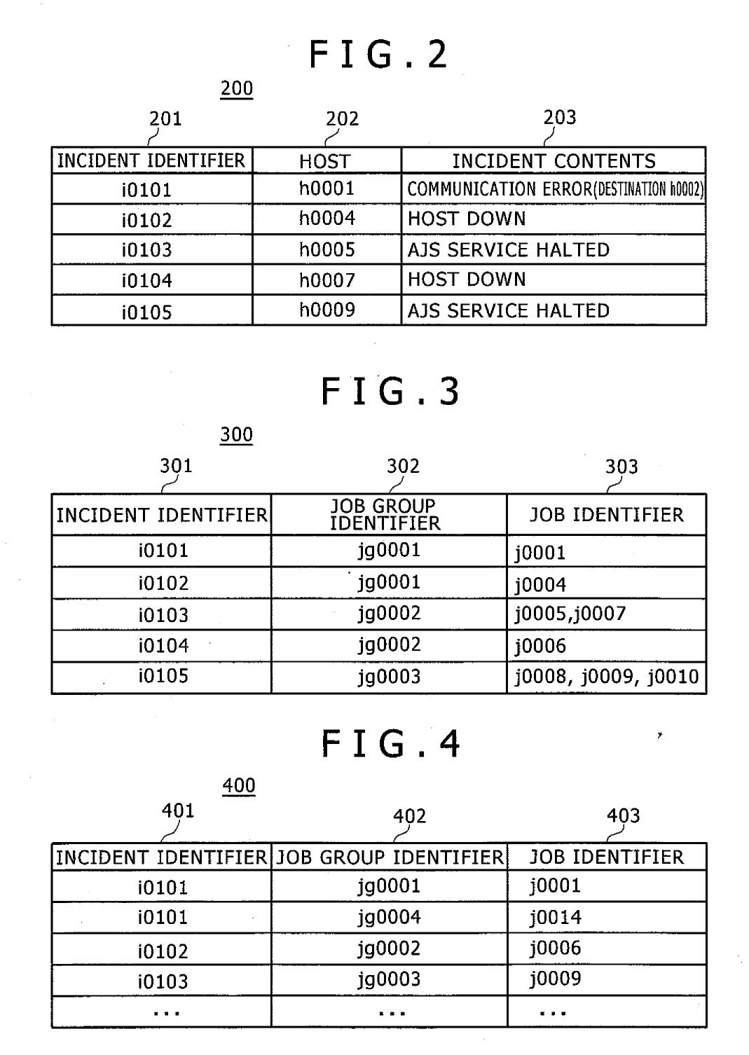

An example of the incident table 200 is shown in FIG. 2. The incident table 200 stores, in each row, the information on the incidents emerged in the business system 10 subject to be managed by the operation management server 100. The incident table 200 includes an incident identifier cell 201, a host cell 202, and an incident contents cell 203. The incident identifier cell 201 stores the incident identifier which is the identification information capable to specify uniquely an incident emerged in the business system 10 subject to be managed by the operation management server 100. The host cell 202 stores the identification information (for example, host name) to uniquely specify the host (business execution server) on which the incident has been emerged. The incident contents cell 203 stores the contents of the incident (for example, host down, i0001, etc.).

When a system operator inputs the information as shown in the incident table 200 through the operation management terminal 101, the operation management server 100 stores the input information into the incident table 200 in the storage unit 111. The operation management server 100 may also stores in the incident table 200 the incident information gathered by using a tool or utility and received by the transmission-reception unit 103.

The incident-job relation table 300 is a spreadsheet style data for storing the relation information between the incident emerged in the business system 10 subject to be managed by the operation management server 100 and the job group and job to be executed on the business execution servers in the business system 10 subject to be managed by the job management server 102. An example of the incident-job relation table 300 is shown in FIG. 3. The incident-job relation table 300 stores relation information in each row between the incidents and the job group and job. The incident-job relation table 300 includes an incident identifier cell 301, an job group identifier cell 302, and an job identifier cell 303. The incident identifier cell 301 stores an incident identifier which uniquely specifies each incident, this incident identifier enables to relate to the incident specified by the incident identifier cell 201 of the incident table 200. The job group identifier cell 302 stores a job group identifier which is the identification information to uniquely specify a job group to which each incident is related, with respect to the job group to be executed on the subject business execution server managed by the job management server 102. The job identifier cell 303 stores a job identifier which is the identification information to uniquely specify a job to which each incident is related, with respect to the job to be executed on the subject business execution server managed by the job management server 102.

The incident-job relation identification unit 105 specifies the information included in the incident-job relation table 300 to store in the incident-job relation table 300 in the storage unit 111.

The reexecution starting job table 400 is a spreadsheet style data, which stores the identification information of the job that is the starting point at the time of reexecution when reexecuting the job group related to the incident. An example of the reexecution start job table 400 is shown in FIG. 4. The reexecution start job table 400 stores in each row the identification information of the job that is the starting point of the reexecution when reexecuting the job group related to the incident. The reexecution start job table 400 includes an incident identifier row 401, a job group identifier row 402, and a job identifier row 403. The incident identifier row 401 stores an incident identifier which is the identification information to uniquely specify each incident, and this incident identifier enables to associate with the incident specified in the incident identifier cell 201 of the incident table 200. The job group identifier row 402 stores a job group identifier which is the identification information to uniquely specify the job group related to the incident, and this job group identifier enables to associate the job group specified by a job group identifier cell 901 of the job group definition table 900. The job identifier row 403 stores the job identifier which is the identification information to uniquely specify a job that is the starting point at the time of reexecution when reexecuting the job group which is associated to the incident, and this job identifier enables to associate with the job specified by a job identifier cell 902 in the job group definition table 900.

The job execution estimation unit 106 specifies the information contained in the reexecution start job table 400 to store in the reexecution start job table 400 in the storage unit 111.

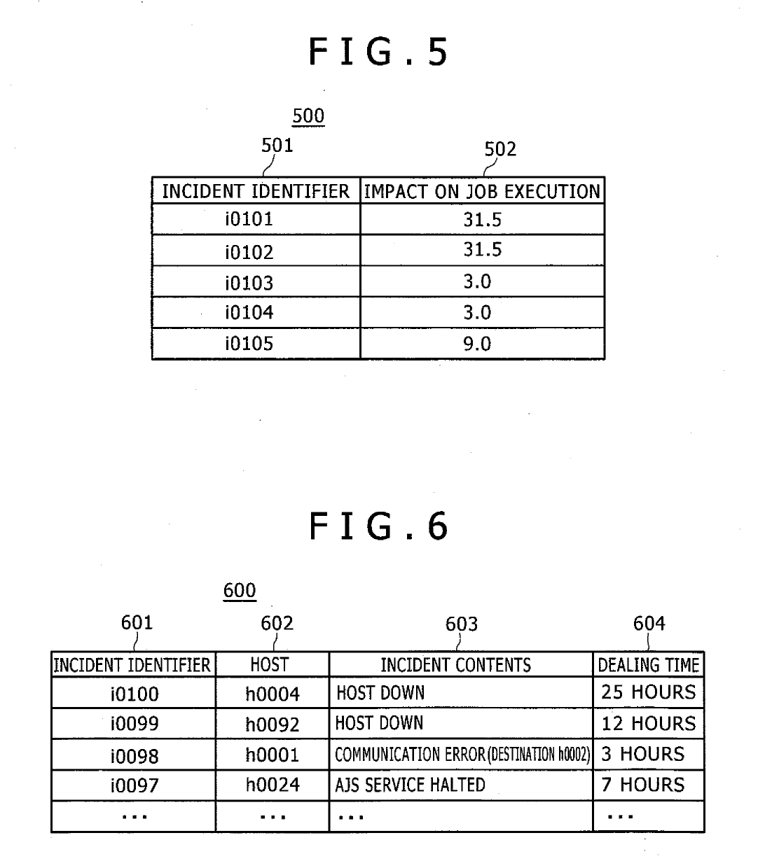

The impact on job execution table 500 is a spreadsheet style data to store the impact on job execution by the incident that affect to the execution of the job group associated to the incident. An example of the impact on job execution table 500 is shown in FIG. 5. The impact on job execution table 500 stores in each row the impact on job execution of the incident that affects to the execution of the job group that associates to the incident. The impact on job execution table 500 includes an incident identifier cell 501, and an impact on job execution cell 502. The incident identifier cell 501 stores an incident identifier which is the identification information to uniquely specify each incident, this incident identifier enables to associate with the incident specified by the incident identifier cell 201 of the incident table 200. The impact on job execution cell 502 stores the impact on job execution of the incident that affects to the execution of the job group that relates to the incident.

The impact on job execution calculation unit 107 calculates the information contained in the impact on job execution table 500 to store in the impact on job execution table 500 in the storage unit 111.

The dealing time history table 600 is a spreadsheet style data to store the information on the incident already dealt and the period of time required to have dealt with the incident. An example of the dealing time history table 600 is shown in FIG. 6. The dealing time history table 600 stores in each row the information on the incident already dealt and the period of time required to have dealt with the incident. The dealing time history table 600 includes an incident identifier cell 601, a host cell 602, an incident contents cell 603, and a dealing time cell 604. The incident identifier cell 601 stores an incident identifier which is the identification information to uniquely specify each incident, this incident identifier enables to associate with the incident specified in the incident identifier cell 201 of the incident table 200. The host cell 602 stores the identification information (for example, host name) to uniquely specify the host (business execution server) on which the incident has been emerged. The incident contents cell 603 stores the contents of the incident (for example, host down, i0001, etc.). The dealing time cell 604 stores the period of time required to have dealt with the incident.

When a system operator inputs the information as shown in the dealing time history table 600 through the operation management terminal 101, the operation management server 100 stores the input information into the dealing time history table 600 in the storage unit 111. The result of measurement of the dealing time of an incident measured by a tool or utility may be input; in turn the operation management server 100 may store input information into the dealing time history table 600 in the storage unit 111.

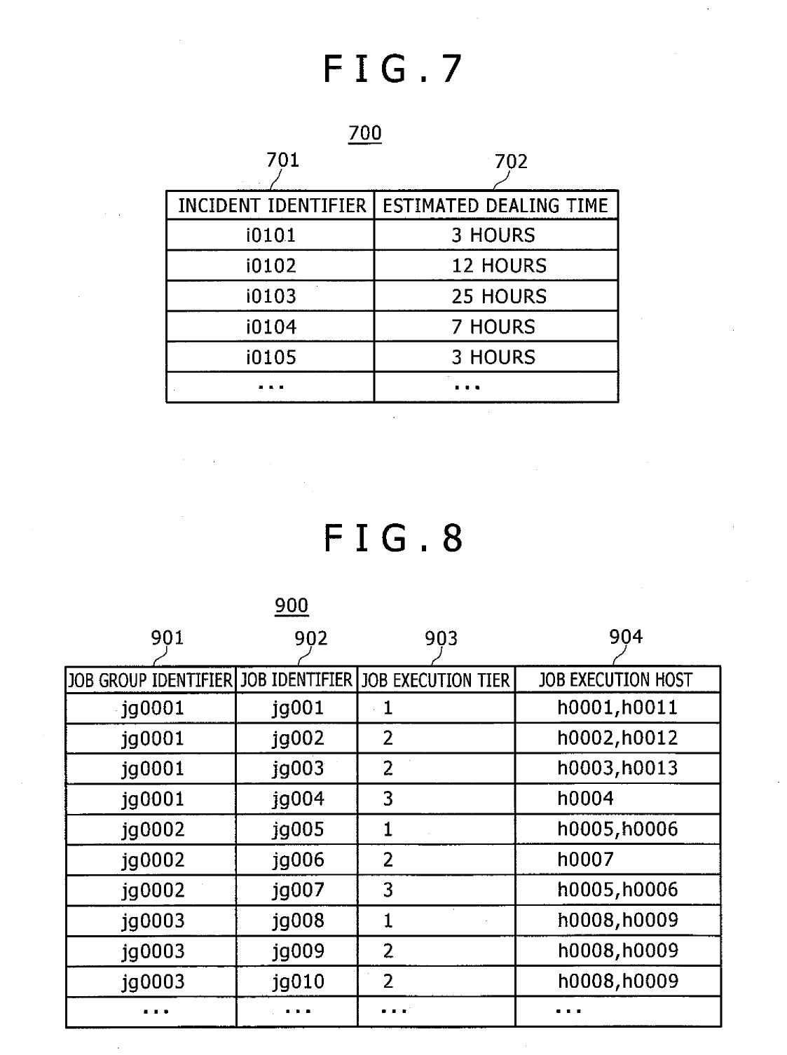

The estimated dealing time table 700 is a spreadsheet style data, which stores the estimated time required for dealing with an incident. An example of the estimated dealing time table 700 is shown in FIG. 7. The estimated dealing time table 700 stores the estimation time required to deal with an incident in each row. The estimated dealing time table 700 includes an incident identifier cell 701, and an estimated dealing time cell 702. The incident identifier cell 701 stores an incident identifier which is the identification information to uniquely specify each incident, this incident identifier enables to associate with the incident specified by the incident identifier cell 201 in the incident table 200. The estimated dealing time cell 702 stores the estimated period of time required to deal with an incident.

The dealing completion time and date calculation unit 109 calculates the information as shown in the estimated dealing time table 700, and stores in the estimated dealing time table 700 in the storage unit 111.

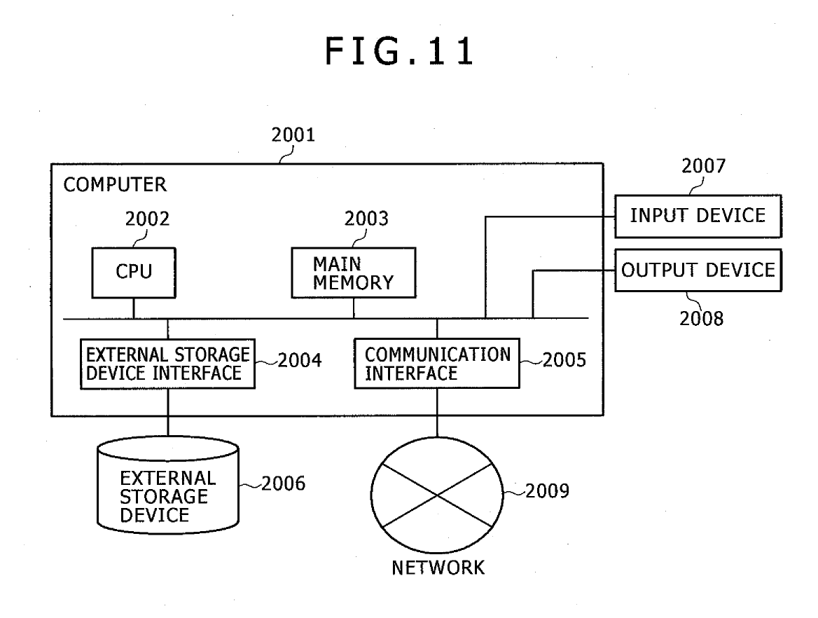

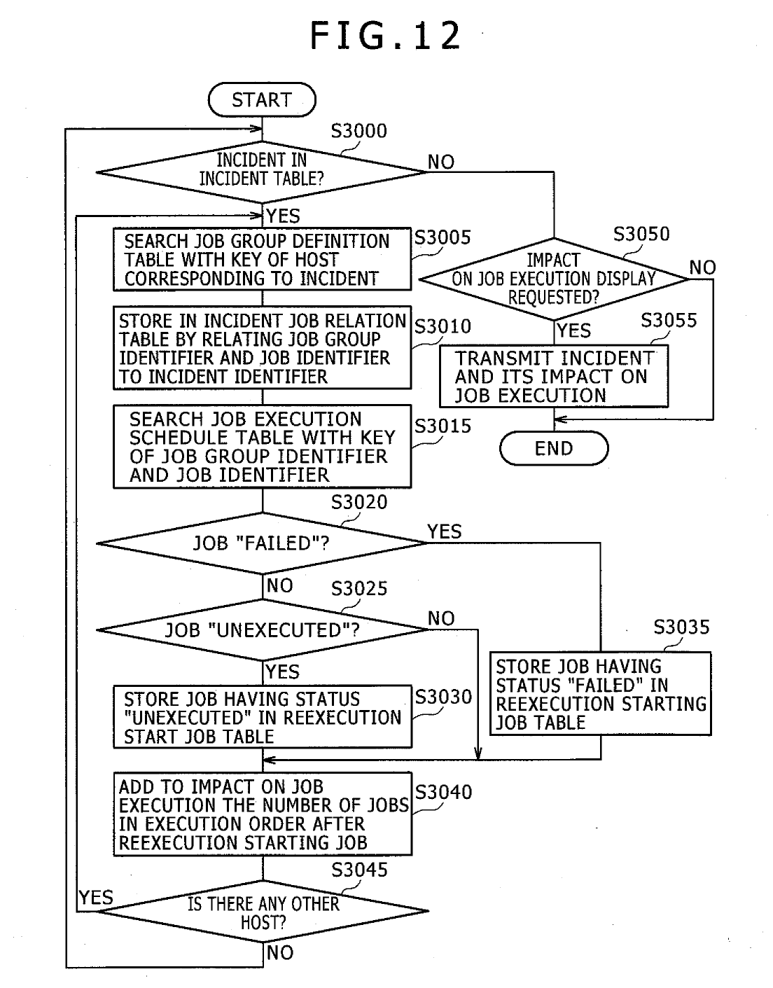

The operation management server 100 runs on a computer 2001 having a hardware configuration as shown in FIG. 11. The computer 2001 has a CPU 2002, a main memory 2003 (such as RAM, ROM, etc.), an external storage device interface 2004, a communication interface 2005 (such as NIC), an external storage device 2006 for storing programs (such as disk devices), input devices 2007 including a keyboard and a mouse, an output devices 2008 such as a display device and a printer.

The transceiving unit 103, the incident detection unit 104, the incident-job relation identification unit 105, the job execution estimation unit 106, the impact on job execution calculation unit 107, the dealing completion time and date calculation unit 109, and the incident display unit 108 are all function blocks, which may be achieved by reading out the program stored on the external storage device 2006 on the main memory 2003 through the external storage device interface 2004 to execute by the CPU 2002. The transceiving unit 103 may also be implemented by a communication interface 2005 and by a communication control program which controls the interface. The storage unit 111 may be achieved by the main memory 2003 and/or the external storage device 2006.

The hardware configuration of the operation management terminal 101 and the job management server 102 can be the same as the computer 2001 shown in FIG. 11, except for the difference in the scale and performance capability.

In FIG. 1, although the operation management server 100, the operation management terminal 101, and the job management server 102 are shown as different server entity, each of servers can be further configured as a server cluster, or these servers may also be configured on one server unit. It should be noted here that the operation management server 100 may not be limited to physical server hardware. In other words, the server may be a virtual server, or a logical server defined such as a cluster configuration.

Now returning to FIG. 1, the operation management terminal 101 will be described in greater details here. The operation management terminal 101 is a server for controlling the data input processing into the operation management server 100 and the data output processing from the operation management server 100. The system operator transmits the information to be stored in the dealing time history table 600 through the operation management terminal 101 to the operation management server 100. The system operator also transmits the information to be stored in the job group definition table 900, the job execution schedule table 1000, and the job reexecution definition table 1100 through the operation management terminal 101 to the job management server 102. Further, the system operator requests the calculation of the impact on job execution of an incident to the operation management server 100 through the operation management terminal 101, and commands to display thus calculated impact on job execution on the operation management terminal 101.

The operation management terminal 101 includes an input unit 112, an output unit 113, a transmission-reception unit 114, and a communication processing unit 115. The input unit 112 accepts the input of various information entered by the system operator, while the output unit 113 outputs the information such as the impact on job execution to the system operator.

The transmission-reception unit 114 is a processing unit performing the transmission and reception processing, which unit transmits to the network 2009 the information received from various processing units in the operation management terminal 101 including the communication processing unit 115, and which unit transmits the information received from the network 2009 to the various processing units. The communication processing unit 115 performs the communication processing with the operation management server 100.

The operation management terminal 101 runs on the computer 2001 having a hardware configuration as shown in FIG. 11. The communication processing unit 115 may be achievable by reading out the program stored in the external storage device 2006 into the main memory 2003, and by executing it on the CPU 2002. The transmission-reception unit 114 may be configurable by a communication interface 2005. The input unit 112 can be configurable by the input devices 2007. The input device 2007 refers to such as a pointing device including a mouse, as well as a keyboard, and so on. The output unit 113 may be configurable by the output devices 2008. The output device 2008 includes for example a monitor display device and a printer device.

Now returning to FIG. 1, the job management server 102 will be described in greater details herein below. The job management server 102 is a server which manages the job group and jobs in the business system 10 subject to be managed by the operation management server 100. The relationship among job management server 102, the business system 10, job group, and job is not limited to a one-to-one basis. More specifically, the job management server 102 may manage one single business system 10, job group and job, or may manage plural job management systems 10, job groups and jobs. Also, plural job management servers 102 may manage the job groups and jobs in the business system 10. Furthermore, the job management server 102 is not limited to be a physical server. More specifically, it can be a virtual server, or a bunch of logical servers defined by a cluster configuration.

The job management server 102 includes a transmission-reception unit 116, a job management unit 117, and a storage unit 118. The transmission-reception unit 116 performs the communication processing between the job management unit 117 and the operation management server 100 or the operation management terminal 101. The job management unit 117 stores into the storage unit 118 the definition information of job group and job, the execution schedule, and the executed history information. The job management unit 117 gathers the current execution status (unexecuted, successfully done, execution in progress, failed to execute, and so on) of the job group and jobs from the execution hosts of the jobs subject to be managed, to store in the storage unit 118. The storage unit 118 stores the job group definition table 900, the job execution schedule table 1000, and the job reexecution definition table 1100.

The job group definition table 900 is a spreadsheet style data, which stores the information on the job group subject to be managed by the job management server 102. An example of the job group definition table 900 is shown in FIG. 8. The job group definition table 900 stores the information on job groups subject to be managed by the job management server 102 in each row. The job group definition table 900 includes the job group identifier cell 901, the job identifier cell 902, a job execution tier cell 903, and a job execution host cell 904. The job group identifier cell 901 stores the job group identifier which is the incident identifier to uniquely specify a job group to be managed by the job management server 102. The job identifier cell 902 stores the job identifier, which is the incident identifier to uniquely specify a job to be managed by the job management server 102. The job execution tier cell 903 stores the order of execution (tier) in a job group. The job execution host cell 904 stores the incident identifier (for example, host name) to uniquely specify the host on which a job is executed, and this incident identifier enables to associate with the host cell 202 in the incident table 200. The row containing plural host names in the job execution host cell 904 in FIG. 8 indicates that the job indicated by the job identifier 902 of that row may be done either one of plural hosts. In other words, plural host names means the host redundancy.

When a system operator enters the information as shown in the job group definition table 900 on the operation management terminal 101, the job management server 102 stores the entered information into the job group definition table 900 in the storage unit 118. The result of gathering the definition information on the job group in the business system subject to be managed by the operation management server 100 by using some tool and utility may be input, in turn the job management server 102 may store the gathered information into the job group definition table 900 in the storage unit 118.

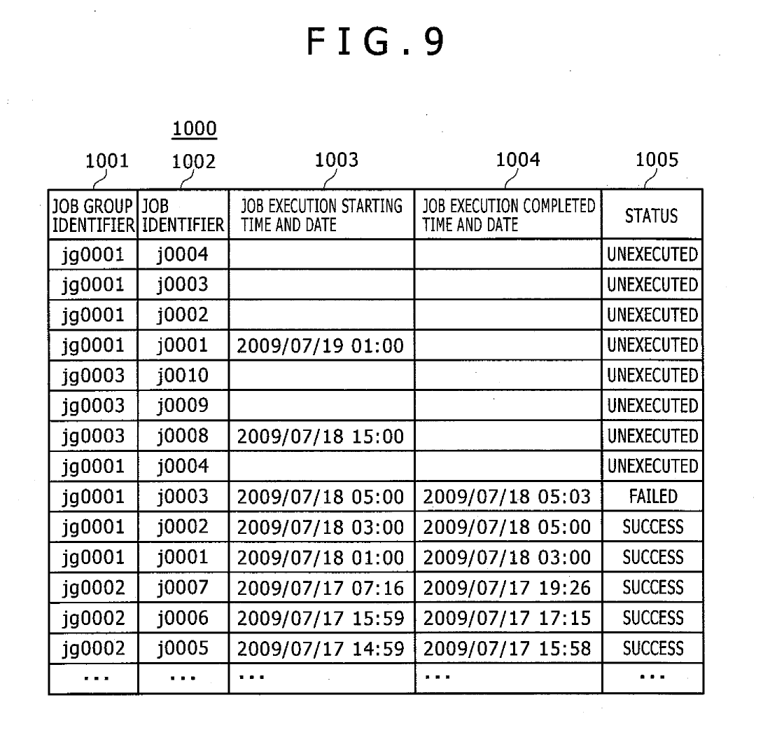

The job execution schedule table 1000 is a spreadsheet style data, which stores the execution status until now of the jobs subject to be managed by the job management server 102 and the execution schedule from now. An example of the job execution schedule table 1000 is shown in FIG. 9. The job execution schedule table 1000 stores in each row the execution status until now of the job group subject to be managed by the job management server 102, and the execution schedule from now. The job execution schedule table 1000 includes a job group identifier cell 1001, a job identifier cell 1002, a job execution starting time and date cell 1003, a job execution completed time and date cell 1004, and a status cell 1005. The job group identifier cell 1001 stores the job group identifier which is the incident identifier to uniquely specify a job group subject to be managed by the job management server 102, and this identifier enables to relate to a job group stored in the job group definition table 900. The job identifier cell 1002 stores a job identifier, which is the incident identifier to uniquely specify a job subject to be managed by the job management server 102, and this identifier enables to associate with a job stored in the job group definition table 900. The job execution starting time and date cell 1003 stores the execution starting time and date of the job already executed, and the scheduled execution starting time and date of the jobs to be done from now. The job execution completed time and date cell 1004 stores the execution completion time and date of the jobs already executed until now. The status cell 1005 stores the execution status (unexecuted, successfully completed, execution in progress, failed to execute, and so on) of the job specified from the job incident identifier stored in the job identifier cell 1002.

When a system operator enters information as shown in the job execution schedule table 1000 through the operation management terminal 101, the job management server 102 stores the entered information into the job execution schedule table 1000 in the storage unit 118. Furthermore, the result of gathering the execution starting/completed time and date as well as the execution status of the job can be entered by using some tool and utility, in turn the job management server 102 may store the gathered information into the job execution schedule table 1000 in the storage unit 118.

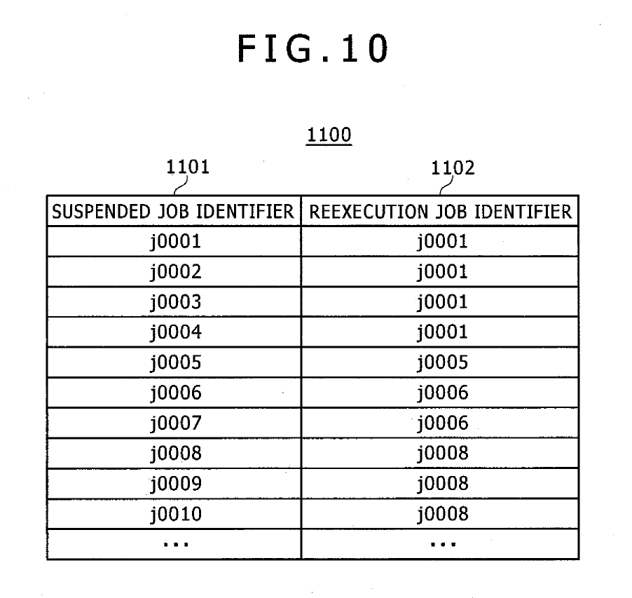

The job reexecution definition table 1100 is a spreadsheet style data to store the job identifier in a job group, which is subject to be the execution starting point when reexecuting after suspending the execution of the job subject to be managed by the job management server 102 due to such as an incident. This identifier specifies from which job the execution may be resumed from within the job group. An example of the job reexecution definition table 1100 is shown in FIG. 10. The job reexecution definition table 1100 stores a job identifier within a job group which is to be the starting point of execution in each row. The job reexecution definition table 1100 includes a suspended job identifier cell 1101, and reexecution job identifier cell 1102. The suspended job identifier cell 1101 stores a job identifier which is the incident identifier to uniquely specify a suspended job to execute due to an incident among the jobs subject to be managed by the job management server 102, this identifier enables to associate it with the job described in the job group definition table 900. The reexecution job identifier cell 1102 stores a job identifier which is the incident identifier to uniquely specify a job within a job group that is to be the starting point when resuming the execution of jobs suspended due to an incident, this identifier enables to associate it with a job described in the job group definition table 900.

When a system operator enters the information as shown in the job reexecution definition table 1100 through the operation management terminal 101, the job management server 102 stores the entered information into the job reexecution definition table 1100 in the storage unit 118. Also, the result of gathering the information on the job to be the starting job at the time of resuming the execution of suspended job by using some tool and utility, the job management server 102 may store the gathered information into the job reexecution definition table 1100 in the storage unit 118.

The job management server 102 runs on a computer 2001 having a hardware configuration as shown in FIG. 11. The transmission-reception unit 116 and the job management unit 117 may be achievable by reading a program stored in the external storage device 2006 into the main memory 2003 and by executing by the CPU 2002. The transmission-reception unit 116 is also achievable by using the communication interface 2005.

In the following, the impact on job execution calculation process in accordance with the best mode for carrying the invention will be described in greater details as some preferred embodiments. Although the impact on job execution calculation process of the incidents is executed by the operation management server 100 having the functionality as incident management device, the description concerning the transmission and reception of tables and information between the operation management server 100 and the job management server 102 or the operation management terminal 101 may be omitted or simplified in order to clarify the description of the following embodiments.

### First Embodiment

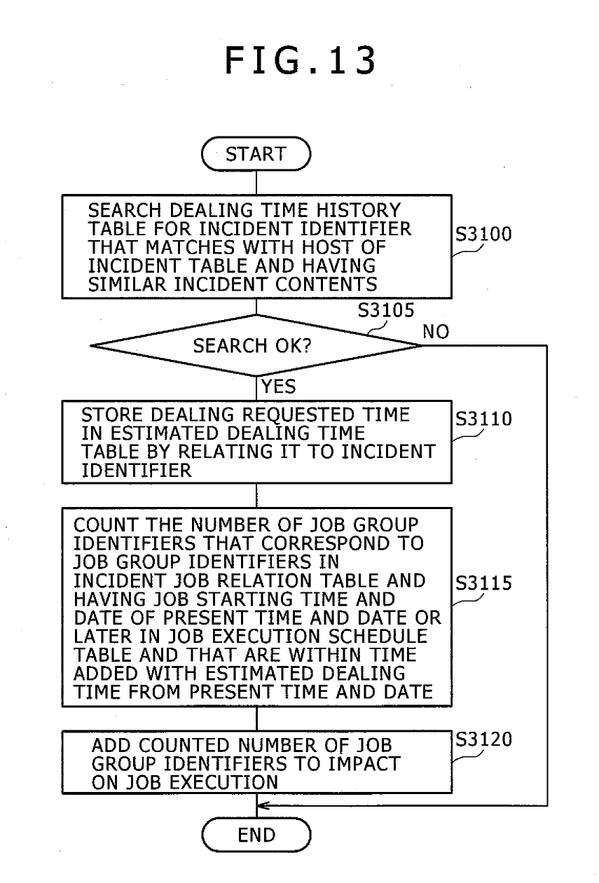

The impact on job execution calculation process of the incidents in accordance with the present embodiment will be described in greater details below. A flow diagram of an example of impact on job execution calculation process by using the operation management server 100 is shown in FIG. 12. The impact on job execution calculation process starts to execute in response to the detection of a new incident by the business system 10, by storing into the incident table 200, and in response to the reception of a display request of the impact on job execution from the operation management terminal 101. The execution may also be started by triggering using a cycle timer.

The incident detection unit 104 confirms whether an incident is stored in the incident table 200 (step 3000). As described earlier, since the incident stored in the incident table 200 may be deleted if the incident has been dealt with (reexecution of the job), an incident stored in the incident table 200 indicates that the incident has been emerged. The incident detection unit 104 branches to step 3050 if there is not an incident stored therein.

If an incident is stored in the incident table 200 (if there are plural incident identifiers 201 stored in the incident table 200 one of these incidents is picked up), the incident-job relation identification unit 105 searches the job group definition table 900 (step 3005) with the host cell 202 as a key corresponding to the incident identifier cell 201 stored in the incident table 200. Then the job group identifier cell 901 and the job identifier cell 902 in the row of the job execution host 904 corresponding to the host cell 202 in the job group definition table 900 are associated with the incident identifier 301 of the incident-job relation table 300 to store as the job group identifier cell 302 and the job identifier cell 303 (step 3010). The incident identifier cell 301 of the incident-job relation table 300 is the incident identifier cell 301 detected in the step 3000. In step 3005, if plural job execution hosts 904 corresponding to the host 202 are found, then plural rows are stored in the incident-job relation table 300. The plural rows here may be plural jobs each belonging to a different job group, or may also be plural jobs which are executed in parallel on one business execution server (job execution host 904) even if these are of the same job group.

The job execution estimation unit 106 retrieves a job identifier 303 having the same job group identifier 302 of the incident-job relation table 300, and using the job group identifier 302 and the job identifier 303 as keys to search the job execution schedule table 1000 (step 3015). If there are plural job identifiers 303 having the same job group identifier 302, plural rows of a combination of the appropriate job group identifier 1001 and the job identifier 1002 may be obtained as the search result. The job execution estimation unit 106 determines whether or not there is a status 1005 indicating ‘failure’ among the job identifiers 1002 obtained as the search result (step 3020).

If there is a status 1005 indicating ‘failure’, the job execution estimation unit 106 relates the job group identifier 1001 and the job identifier 1002 having the status 1005 indicating ‘failure’ to the corresponding incident identifier 301 of the incident-job relation table 300, and stores into the reexecution start job table 400 as the incident identifier 401, the job group identifier 402, and the job identifier 403 (step 3035). If in step 3020, there are obtained plural job group identifiers 1001 and job identifiers 1002 having the status 1005 indicating ‘failure’ (this means that there are plural jobs belonging to the same job group which has the status 1005 indicating ‘failure’), then the job group definition table 900 is referred to store the job identifier 1002 having the earliest job execution tier 903 into the job identifier 403 of the reexecution start job table 400. Then the process proceeds to step 3040.

If there is nothing having the status 1005 indicating ‘failure’ in the step 3020, the job execution estimation unit 106 determines whether or not there is one having the status 1005 indicating ‘unexecuted’ among the job identifiers 1002 obtained as the search result in step 3015 (step 3025). If there is no job identifier 1002 having the status 1005 indicating ‘unexecuted’, the process proceeds to step 3040.

In step 3025 if there is one job identifier 1002 having the status 1005 indicating ‘unexecuted’, the job execution estimation unit 106 relates the job group identifier 1001 and the job identifier 1002 having the status 1005 indicating ‘unexecuted’ to the corresponding incident identifier 301 of the incident-job relation table 300 to store as the incident identifier 401, the job group identifier 402, and the job identifier 403 into the reexecution start job table 400 (step 3030). In step 3025 if there are plural job group identifiers 1001 and the job identifiers 1002 having the status 1005 indicating ‘unexecuted’ (if plural jobs belonging to the same job group have the status ‘unexecuted’), then the job group definition table 900 is referred to store the job identifier 1002 having the earliest job execution tier 903 into the job identifier 403 of the reexecution start job table 400.

The impact on job execution calculation unit 107 refers to the job group definition table 900 to count the number of jobs in the order of execution after the job execution tier 903 of the job identifier 403 of the reexecution start job table 400 among the job group identifier 901 indicating the job group identifier 402 of the reexecution start job table 400, and to associate the count result to the incident identifier 501 of the impact on job execution table 500 corresponding to the incident identifier 401 of the reexecution start job table 400 so as to add to the impact on job execution 502 (step 3040). Though the description of the initialization of the impact on job execution table 500 has been omitted, if there are incidents present in step 3000 and at the time of retrieving one of them, the impact on job execution table 500 stores an incident identifier 501 in correspondence with the incident retrieved, and its corresponding impact on job execution is initialized to 0. In this way the impact on job execution 502 can be obtained for each incident identifier 501 at the time when executing the process shown in FIG. 12.

Then it is determined if there is another host corresponding to the incident identifier 201 of the incident table 200 (step 3045), if there is another host, then the process proceeds to step 3005, and if not then the process proceeds to step 3000. In the incident table 200 shown in FIG. 2, the incident identifier 201 and the host 202 are shown in the relation of one to one basis; however there may be cases in which one same incident affects to plural hosts 202 (business execution servers). For example, in a system in which each of plural virtual servers generated on one single physical server is operational as business execution server, an incident emerged on the physical server may affect to the operation of the plural virtual servers thereon.

In step 3000, if an incident is not stored in the incident table 200, then the incident display unit 108 determines if there is a display request of the impact on job execution from the operation management terminal 101 (step 3050). If no request is present, then the process terminates. On the other hand if there is a request, the incident display unit 108 reads out the incident table 200 and the impact on job execution table 500, and transmits each of the impact on job execution of the incident identifier 501 of the impact on job execution table 500 along with the incident contents 203 corresponding to each incident identifier 201 of the incident table 200 to the operation management terminal 101 through the transceiving unit 103 (step 3055). The incident display unit 108 at the time of transmitting a response to the operation management terminal 101 may also display on the output device 2008 connected to the operation management server 100. After confirming the successful transmission to the operation management terminal 101, the process terminates.

In accordance with the preferred embodiment, based on the execution estimation in the future of the job group in association with an incident (any scheduled but unexecuted jobs listed in the job execution schedule table 1000 are also subject), the impact on job execution of the incident will be more serious when there are more jobs to be executed in the future. Accordingly even if there are many incidents registered at the same time, the operator may deal with these incidents at a higher efficiency based on the impact on job execution calculated.

### Second Embodiment

In the first preferred embodiment of the present invention the impact on job execution of the incident with respect to the execution of the job group relating to the incident is calculated by aggregating the number of jobs to be executed after the job suspended due to the incident or after the job unexecuted. In the present embodiment, the job to be started to reexecute at the time when a job is suspended is defined in advance, to specify the job to be started to reexecute based on the definition information to aggregate the number of jobs to be executed after the specified job in order to calculate the impact on job execution.

In the first preferred embodiment of the present invention, in step 3035 the job execution estimation unit 106 associates the job group identifier 1001 and job identifier 1002 having the status 1005 ‘failure’ with their corresponding incident identifier 301 of the incident-job relation table 300 to store them as the incident identifier 401, the job group identifier 402, and the job identifier 403 in the reexecution start job table 400. In the present embodiment the job execution estimation unit 106 searches the suspended job identifier 1101 of the job reexecution definition table 1100 with the job identifier 1002 having the status 1005 indicating ‘failure’ as the key to obtain the corresponding the reexecution job identifier 1102, then stores thus obtained reexecution job identifier 1102 as the job identifier 403 in the reexecution start job table 400. The incident identifier 401 and the job group identifier 402 to be stored in the reexecution start job table 400 are identical to those in the first preferred embodiment.

In accordance with the preferred embodiment, since the earliest job to be reexecuted can be specified in correspondence with the job suspended due to the incident, the impact on job execution of the incident including the job to be reexecuted under the normal circumstances. For example, there may be a job group having a job B that the file output from another job A is input to perform a predetermined process onto the file then to delete the file and further continues the process. In this case, if the job is suspended after the job B deletes the file, since the file to be input to the job B is already deleted when the job B is reexecuted again, the job B may or may not output a false result, or the job B itself may terminate abnormally. Therefore, by defining in the job reexecution definition table 1100 the job A as the reexecution job identifier, the reexecution may be successfully achieved since the job A which is to be reexecuted under the normal circumstances when the job B is suspended (or ‘failed’ to execute) due to an incident, the corresponding impact on job execution can be thus determined.

In accordance with the present embodiment the job execution can be successfully achieved when another job that has been executed prior to the aborted job is to be reexecuted again as have been described. In such a case, a combination of the aborted job identifier 1101 and the reexecution job identifier 1102 is previously defined in the job reexecution definition table 1100, if there is the aborted job identifier 1101 is present in the job reexecution definition table 1100 the reexecution job identifier 1102 will be the reexecution starting job, otherwise if there is not the aborted job identifier 1101 in the job reexecution definition table 1100 the job sequence will be just executed as have been described according to the first preferred embodiment of the present invention. In this manner the job reexecution definition table 1100 can be sufficient to store a combination only when the aborted job identifier 1101 is different from the reexecution job identifier 1102. The size of the job reexecution definition table 1100 may therefore be smaller.

### Third Embodiment

In the present embodiment, by aggregate the estimated execution time of the jobs required to be reexecuted, the impact on job execution of the incident may be defined by the aggregated result.

In the first preferred embodiment of the present invention, in step 3040 the impact on job execution calculation unit 107 refers to the job group definition table 900 to count the number of jobs after the execution tier 903 in the order of execution of the job identifier 403 in the reexecution start job table 400 among the job group identifier 901 indicating the job group identifier 402 of the reexecution start job table 400 so as to add to the impact on job execution 502 the counting result by associating the counting result to the incident identifier 501 of the impact on job execution table 500 which corresponds to the incident identifier 401 of the reexecution start job table 400.

In the present embodiment, the impact on job execution calculation unit 107 refers to the job group definition table 900 to specify the jobs in the execution order after the execution tier 903 of the job identifier 403 of the reexecution start job table 400 among the job group identifier 901 indicating the job group identifier 402 of the reexecution start job table 400. The estimated execution time of jobs specified thereby is determined by the difference between the corresponding job execution starting time and date 1003 and the job execution completed time and date 1004 by referring to the job execution schedule table 1000. In a case in which there are plural rows of the job execution starting time and date 1003 and the job execution completed time and date 1004 stored with respect to the same job group identifier 1001 and the job identifier 1002 in the job execution schedule table 1000, the mean value of the difference therebetween is first determined to make this mean value the estimated execution time of the job. The impact on job execution calculation unit 107 stores thus determined estimated job execution time into the impact on job execution table as the impact on job execution 502.

In accordance with the preferred embodiment of the present invention, based on the estimation of execution in the future of the job group related to the incident (unexecuted job scheduled in the job execution schedule table 1000 are also to be subject), the impact on job execution in correspondence with the incident will be more serious if the estimated execution time of the job required to be reexecuted is longer.

### Fourth Embodiment

In the present embodiment the number of scheduled hosts used by the jobs required to be executed is the impact on job execution.

In this embodiment the impact on job execution calculation unit 107 refers to the job group definition table 900 to specify the jobs in the execution order after the execution tier 903 of the job identifier 403 of the reexecution start job table 400 among the job group identifier 901 indicating the job group identifier 402 of the reexecution start job table 400. By referring to the job group definition table 900, a list of the job execution host 904 for each job specified. The list is the logical sum of the job execution host 904 of each job specified. In other words, when there are plural jobs which are to be executed by the same job execution host 904, that job execution host 904 will be the only job execution host 904. The number of the job execution hosts 904 specified as a list is stored as the impact on job execution 502 in the impact on job execution table.

In accordance with the preferred embodiment, based on the estimation of execution in the future of the job group related to the incident (the unexecuted jobs scheduled in the job execution schedule table 1000 are also subjected), the impact on job execution corresponding to the incident will be more serious when the number of the job execution hosts of the job required to be reexecuted is larger (i.e., the possibility of the use of much more resources is higher).

### Fifth Embodiment

The present embodiment calculates the redundancy of the hosts for the scheduled execution for the job required to be reexecuted to determine the impact on job execution by the smallness of the redundancy.

In the present embodiment, the impact on job execution calculation unit 107 refers to the job group definition table 900 to specify the jobs in the execution order after the execution tier 903 of the job identifier 403 of the reexecution start job table 400 among the job group identifier 901 indicating the job group identifier 402 of the reexecution start job table 400. The job group definition table 900 is referred to obtain the number of hosts in the cell of the job execution host 904 for each job specified to store the inverse number thereof in the impact on job execution table as the impact on job execution 502. For example, when there are two hosts stored in the job execution host 904, the inverse thereof, ½ will be put into the impact on job execution. The host number in the job execution host 904 indicates the redundancy of the hosts, meaning that the impact on job execution will be less if the redundancy is greater.

In accordance with the preferred embodiment, based on the estimation of execution in the future of the job group related to an incident, the impact on job execution of the incident will be more serious if the redundancy of the estimated execution hosts for the job required to be reexecuted is smaller (i.e., the possibility that the job execution can be replaced by another host is higher).

### Sixth Embodiment

In the present embodiment the required time to deal with an incident is estimated to put into the impact on job execution the number of failure of the execution of the job group within the estimated dealing deadline time from the execution schedule of the job group related to the incident.

In the present embodiment the impact on job execution addition process shown in FIG. 13 is performed in place of the step 3040 of FIG. 12. The dealing completion time and date calculation unit 109 searches from within the dealing time history table 600 an incident identifier 601 which matches with the host 202 of the incident table 200 and which is similar to the incident contents 203 (step 3100). The match with the host 202 of the incident table 200 occurs when the host 602 of the dealing time history table 600 is matched. The similarity to the incident contents 203 occurs when one of the following is matched: (1) the incident contents 203 is matched with the incident contents 603 of the dealing time history table 600, (2) the incident contents 203 is encompassed by the incident contents 603, and (3) the incident contents 603 is encompassed by the incident contents 203. In any one of these cases the incident contents 203 is called to be similar to the incident contents 603. If no result is obtained (step 3105), the process terminates.

If the result is obtained, the dealing time 604 corresponding to the incident identifier 601 is stored and relates the incident identifier 701 in the estimated dealing time table 700 (step 3110). The incident identifier 701 is the incident identifier 201 of the incident table 200, which is retrieved in step 3005.

The impact on job execution calculation unit 107 counts the number of the job group identifier 1001 that the job execution starting time and date 1003 is after the present time and date among the job group identifier 1001 of the job execution schedule table 1000 corresponding to the job group identifier 302 of the incident-job relation table 300 and that is to be executed by the time added with the estimated dealing time 702 corresponding to the job group identifier 701 from the present time (step 3115). The counted number of job group identifiers 1001 is added to the impact on job execution 502 of the corresponding incident identifier 501 of the impact on job execution table 500.

In accordance with the preferred embodiment, based on the estimation of the execution in the future of the job group related to an incident, the impact on job execution of the incident will be more serious when the number of scheduled execution of the job group to be executed by the estimated dealing time of the incident is larger (i.e., the number of time that the deal with the incident is not met the deadline of the execution of the job group is larger).

In accordance with the preferred embodiment as have been described above, the impact on job execution due to an incident with respect to the business system can be output as the quantitative impact on job execution related to the job or job group to be reexecuted by the business execution server which is constituting the business system as well as the job or job group to be already scheduled to execute, so as to assist the dealing with the incident by the system operator.

What is claimed is:

1. A method of managing incidents generated on an business system by an operation management server, said operation management server being connected to said business system including business execution servers referred as hosts and to a job management server managing the execution of jobs in the business execution servers, the method on said operation management server comprising:
in response to the generation of an incident generated on a host, specifying job and job groups executed by the host by referring to an incident table storing an relation between the incident and the host, and by referring to a job group definition table, from the job management server, storing a relation among one of job groups, each job group having a plurality of jobs, one of jobs executed by the host, and the host;
specifying reexecuting jobs to be reexecuted and unexecuted jobs in response to said incident, by referring to the execution status of the jobs stored in a job execution schedule table from the job management server; and
determining an impact on job execution affected by the incident to the business system by associating said incident with said reexecuting jobs and said unexecuted jobs.

2. The method of managing incidents according to claim 1,
wherein said impact on job execution is determined as at least one of:
(1) the number of said specified reexecuting jobs and unexecuted jobs stored in the job execution schedule table;
(2) the execution time of said specified reexecuting jobs and said unexecuted jobs stored in the job execution schedule table;
(3) the number of hosts to execute said specified reexecuting jobs and unexecuted jobs stored in the job group definition table;
(4) the redundancy of the hosts to execute said specified reexecuting jobs and unexecuted jobs stored in the job group definition table; and
(5) the number of scheduled executions of said job group stored in the job execution schedule table by the dealing completion schedule time of said incident by referring to the dealing time history table associating said incident with a dealing time.

3. The method of managing incidents according to claim 2,
wherein a job to be started reexecuting among said specified reexecuting jobs has the first execution tier in the job group of the job group definition table among jobs having the execution status marked as ‘failure’.

4. The method of managing incidents according to claim 3,
wherein the job to be started reexecuting among said specified reexecuting jobs is predetermined in the job reexecution definition table as the job to be started reexecuting corresponding to jobs having the execution status marked as ‘failure’.

5. The method of managing incident according to claim 2,
wherein a job to be started executing among said specified unexecuted jobs is a job having the first execution tier in the job group stored in the job group definition table among the jobs having the job execution status marked as ‘unexecuted’ when there is no job having the execution status of the job marked as ‘failure’ in the job group of the job group definition table.

6. An operation management server connected to an business system including business execution servers referred to as hosts and to a job management server for managing the execution of jobs by the business execution servers, comprising:
an incident-job relation specifying unit which specifies job and job groups executed by a host on which an incident is generated, in response to the generation of the incident generated on the business system, by referring to an incident table storing an relation between the incident and the host, and by referring to a job group definition table, from the job management server, storing a relation among one of job groups, each job group having a plurality of jobs, one of jobs executed by the host and the host;
a job execution estimation unit which specifies reexecuting jobs to be reexecuted and unexecuted jobs in response to said incident, by referring to the execution status of the jobs stored in a job execution schedule table from the job management server; and
an impact on job execution calculation unit which determines the impact on job execution affected by said incident to the business system by associating said incident with said reexecuting jobs and said unexecuted jobs.

7. The operation management server according to claim 6,
wherein said impact on job execution calculation unit determines said impact on job execution as at least one of:
(1) the number of said specified reexecuting jobs and unexecuted jobs stored in the job execution schedule table;
(2) the execution time of said specified reexecuting jobs and unexecuted jobs stored in the job execution schedule table;
(3) the number of hosts to execute said specified reexecuting jobs and unexecuted jobs stored in the job group definition table;
(4) the redundancy of the hosts to execute said specified reexecuting jobs and unexecuted jobs stored in the job group definition table; and
(5) the number of scheduled executions of said job group stored in the job execution schedule table by the dealing completion schedule time of said incident by referring to the dealing time history table associating said incident with a dealing time.

8. The operation management server according to claim 7,
wherein a job to be started reexecuting among said specified reexecuting jobs has the first execution tier in the job group of the job group definition table among jobs having the execution status marked as ‘failure’.

9. The operation management server according to claim 8,
wherein the job to be started reexecuting among said specified reexecuting jobs is predetermined in the job reexecution definition table as the job to be started reexecuting corresponding to jobs having the execution status marked as ‘failure’.

10. The operation management server according to claim 7,
wherein a job to be started executing among said specified unexecuted jobs is a job having the first execution tier in the job group stored in the job group definition table among the jobs having the job execution status marked as ‘unexecuted’ when there is no job having the execution status of the job marked as ‘failure’ in the job group of the job group definition table.
